(19) United States
(12) Patent Application Publication
(10) Pub. No.: US 2016/0224127 A1
(43) Pub. Date: Aug. 4, 2016

(54) METHOD FOR CONTROLLING A CURSOR, ELECTRONIC DEVICE AND INPUT DEVICE

(71) Applicant: Lenovo (Beijing) Co., Ltd., Beijing (CN)

(72) Inventors: Haoqiang ZHOU, Beijing (CN); Shulu GU, Beijing (CN); Wenwu PENG, Beijing (CN)

(73) Assignee: Lenovo (Beijing) Co., Ltd., Beijing (CN)

(21) Appl. No.: 14/755,481

(22) Filed: Jun. 30, 2015

(30) Foreign Application Priority Data
Jan. 30, 2015 (CN) 201510050663.9

(51) Int. Cl. G06F 3/038; G06F 3/033

(52) U.S. Cl. CPC G06F 3/038; G06F 3/033

(57) ABSTRACT

An information processing method is applied in a controlled device. The method includes: receiving an input operation for the control device to control a cursor of the controlled device, controlling the cursor to move at a first rate based on an input parameter of the input operation, and controlling the cursor to move at a second rate in a first region, the first rate being less than the second rate. An electronic device and an input device are also provided.

### CROSS REFERENCE TO RELATED APPLICATIONS

The present application claims the priority to Chinese Patent Application No. 201510050663.9, titled “INFORMATION PROCESSING METHOD, CONTROLLED DEVICE AND INPUT DEVICE”, filed Jan. 30, 2015 with the State Intellectual Property Office of People's Republic of China, which is incorporated herein by reference in its entirety.

### FIELD

The disclosure relates to the technical field of touch control, and in particular to an information processing method, a controlled device and an input device.

### BACKGROUND

With the development of electronic technology, an airmouse is used more widely.

Generally, slight drift of a cursor such as cursor jitter may occur due to a touch operation in the use of the airmouse, so that an error click may occur due to the cursor jitter when a user operates the airmouse, thereby affecting user experience.

### SUMMARY

It is provided a method for controlling a cursor, including: receiving an input operation of a control device to control the cursor; controlling the cursor to move at a first rate based on an input parameter from the input operation, and controlling the cursor to move at a second rate in a first region, wherein the first rate is less than the second rate.

Also, an electronic device is provided. The electronic device includes: an input receiving unit configured to receive an input operation of a control device to control a cursor; an operation responding unit configured to control the cursor to move at a first rate based on an input parameter of the input operation and trigger a first control unit when the cursor moves into a first region; and the first control unit configured to control the cursor to move at a second rate in the first region, wherein the first rate is less than the second rate.

Further, an input device is provided. The input device includes a control device and the above discussed electronic devices.

As can be seen from the above technical solutions, according to the information processing method, the controlled device and the input device, the controlled device responds to the input operation for controlling the cursor of the controlled device after receiving the input operation, and control the cursor to move at the second rate greater the first rate to the reference point in the first region when the cursor moves at the first rate into the first region, so that the cursor is always in the first region to respond to operations regardless of whether subsequent operations such as click are performed on the cursor. In this way, slight drift of the cursor such as the cursor jitter is avoided, and the accuracy of subsequent operations such as click is further improved, thereby improving user experience.

### BRIEF DESCRIPTION OF THE DRAWINGS

Technical solutions of the embodiments of the present application and/or the related art will be illustrated more clearly with the following brief description of the drawings. Apparently, the drawings referred in the following description constitute only some embodiments of the disclosure. Those skilled in the art may obtain some other drawings from these drawings without any creative work.

FIG. 1 is a flow chart of an information processing method according to a first embodiment of the disclosure;

FIG. 2a, FIG. 2b, FIG. 2c are application example views of embodiments of the disclosure;

FIG. 3 is a flow chart of an information processing method according to a second embodiment of the disclosure;

FIG. 4 is a flow chart of an information processing method according to a third embodiment of the disclosure;

FIG. 5 is a flow chart of an information processing method according to a fourth embodiment of the disclosure;

FIG. 6 is a schematic structural diagram of a controlled device according to a fifth embodiment of the disclosure;

FIG. 7 is a schematic structural diagram of a controlled device according to a sixth embodiment of the disclosure;

FIG. 8 is a schematic structural diagram of a controlled device according to a seventh embodiment of the disclosure;

FIG. 9 is a schematic structural diagram of a controlled device according to an eighth embodiment of the disclosure; and

FIG. 10 is a schematic structural diagram of an input device according to a ninth embodiment of the disclosure.

### DETAILED DESCRIPTION

The technical solution according to the embodiments of the present disclosure is described clearly and completely as follows in conjunction with the accompanying drawings. It is clear that the described embodiments are only a part of the embodiments according to the present disclosure. Any of other embodiments obtained by those skilled in the art based on the embodiments in the present disclosure without any creative work falls in the scope of the present disclosure.

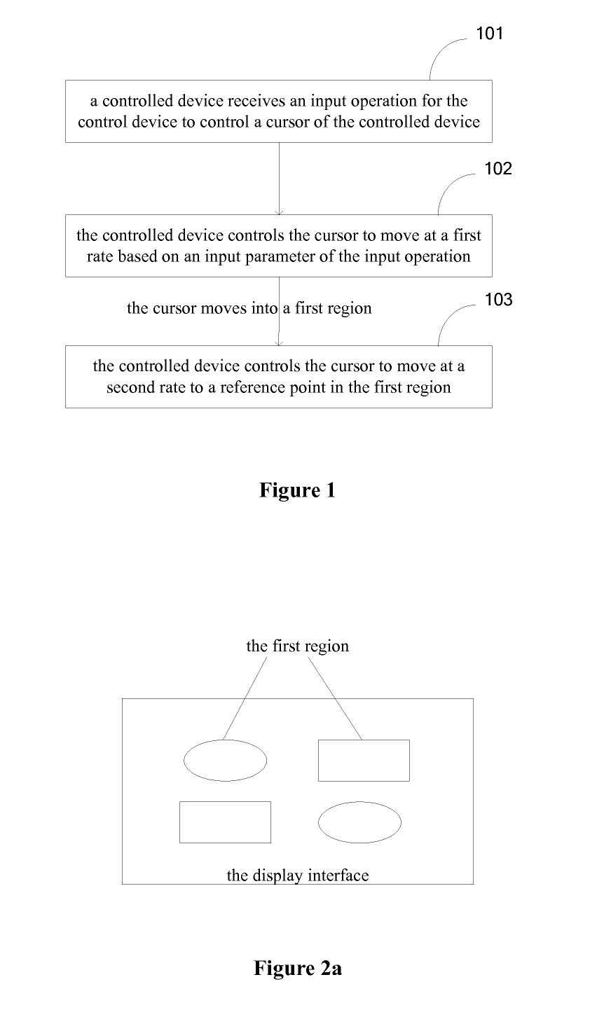

Reference is made to FIG. 1, which is flow chart of an information processing method according to a first embodiment of the disclosure. The information processing method is applied in a controlled device connected to a control device through a communication module. The control device may be a mouse such as a wired mouse, a wireless mouse, and an airmouse. The control device may be connected to the controlled device through a wired communication module or a wireless communication module, such as a wired connection module with a serial interface or a wireless connection module such as Bluetooth and WiFi, to control a cursor of the controlled device.

In the present embodiment, the information processing method may include step 101 to step 103.

In step 101, the controlled device receives an input operation for the control device to control a cursor of the controlled device.

The input operation may be a touch slide operation or the like, and a user operates the control device to generate operating data for controlling the cursor of the controlled device.

In step 102, the controlled device controls the cursor to move at a first rate based on an input parameter from the input operation, in response to the input operation. The method proceeds to step 103 when the cursor moves into a first region in which a first object is displayed.

The input parameter from the input operation may include: a direction of the operation, a magnitude of the operation, a length of the operation track and a duration of operation sliding or the like. In the present embodiment, the controlled device determines a second rate at which the cursor moves based on the input parameter, in response to the input operation.

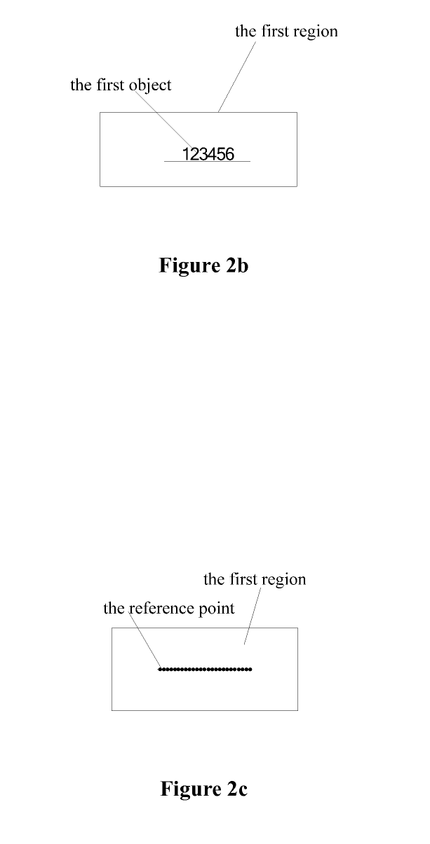

It should be noted that the first region may be a region on a display interface corresponding to the controlled device, and there may be multiple first regions displayed in the display interface. The cursor may slide or stay in any one of the first regions when the user controls the cursor of the controlled device through the control device, as shown in FIG. 2a.

In addition, the first object displayed in the first region may be a single object, and may also be a sub-object of combination of multiple sub-objects, for example, a single icon in the icon objects or a text object of a hyperlink object including multiple text objects, as shown in FIG. 2b.

In step 103, the controlled device controls the cursor to move at the second rate to a reference point in the first region.

It can be seen from the above description, in the present embodiment, after the second rate is determined based on the input parameter, the cursor is controlled to move at the second rate in the first region, and the moving direction of the cursor is a direction toward the reference point in the first region.

It should be noted that there may be multiple reference points in the first region. The reference point may be in a center region of the first region. For example, the reference point is positioned at a center point of the first region, or the reference point is positioned in a center line of the first region. That is, the moving direction of the cursor in the first region may be a direction toward any one of the reference points in the first region. As shown in FIG. 2c, the reference points in the first region are connected into a reference line. In the present embodiment, the cursor is controlled to move at the second rate toward the reference line after the cursor enters into the first region.

The first rate is less than the second rate.

In the present embodiment, after the cursor enters into the first region, the cursor is controlled to move at a rate greater than the first rate to the reference point, in order to reach the reference point as soon as possible. Once the cursor reaches the reference point, the cursor stops moving, thereby the cursor jitter is avoided.

In the present embodiment, if the user operates the control device to generate the input operation for the control device to control the cursor of the controlled device, the input operation is received and the cursor is controlled to move at the first rate in response to the input operation. When the cursor moves into any one of the first regions, the cursor is controlled to move at the rate greater than the first rate to the reference point or the reference line including multiple reference points in the first region. In the embodiment, the cursor is always in the first region regardless of whether subsequent operations such as click are performed on the cursor, thereby avoiding the cursor jitter.

As can be seen form the above technical solutions, in the information processing method according to the first embodiment of the disclosure, the controlled device responds to the input operation for controlling the cursor of the controlled device after receiving the input operation, and control the cursor to move at the second rate greater than the first rate to the reference point in the first region when the cursor moves at the first rate into the first region, so that the cursor is always in the first region to respond to operations regardless of whether subsequent operations such as click are performed on the cursor. In this way, slight drift of the cursor such as the cursor jitter is avoided, and the accuracy of subsequent operations such as click is further improved, thereby improving user experience.

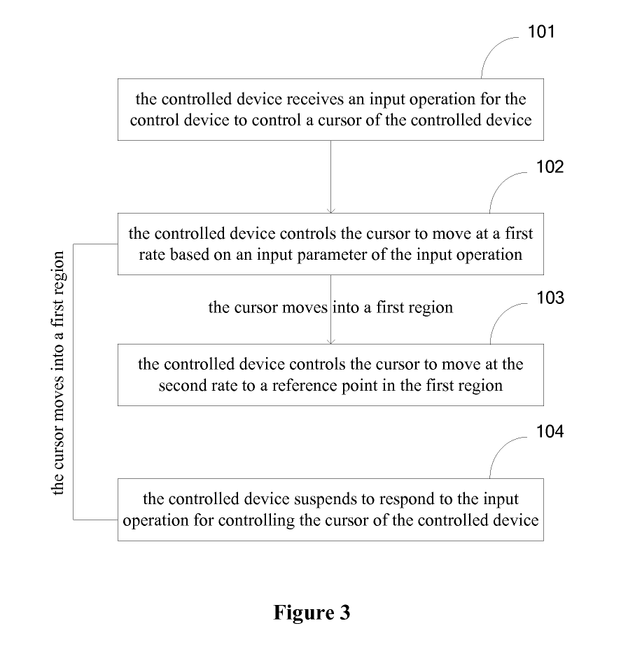

Reference is made to FIG. 3, which is a flow chart of an information processing method according to a second embodiment of the disclosure. The information processing method further includes step 104 when the cursor moves into the first region in the step 102.

In step 104, the controlled device suspends to respond to the received input operation for controlling the cursor of the controlled device is suspended.

In the present embodiment, responding to the received input operation for controlling the cursor of the controlled device is suspended when the cursor moves to the reference point in the first region, so that the cursor stays at the reference point before other operations are received, the stability of the cursor is ensured, thereby avoiding the cursor jitter.

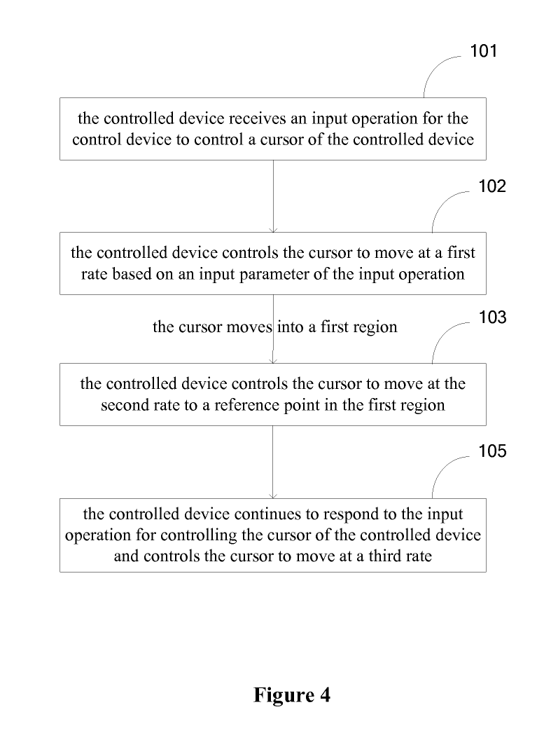

Reference is made to FIG. 4, which is a flow chart of an information processing method according to a third embodiment of the disclosure. After the step 103, the information processing method further includes step 105.

In step 105, the controlled device continues to respond to the received input operation for controlling the cursor of the controlled device, and controls the cursor to move at a third rate.

The third rate is less than the first rate.

In the present embodiment, responding to the received input operation for controlling the cursor of the controlled device is continued after the cursor moves to the reference point in the first region. The responding action in this case is different form the responding action in the case that the cursor is not in the first region. That is, in the present embodiment, the cursor is controlled to move at the third rate less than the first rate to a region such as an edge region of the first region. Hence, the moving rate at which the cursor moves in the first region is reduced, and a moving distance the cursor moves in a preset period is reduced. In this way, the stability of the cursor is ensured in a certain degree with ensuring the responding to the input operation, thereby avoiding the violent cursor jitter.

It should be noted that a first difference between the first rate and the third rate is equal to a second difference between the first rate and the second rate.

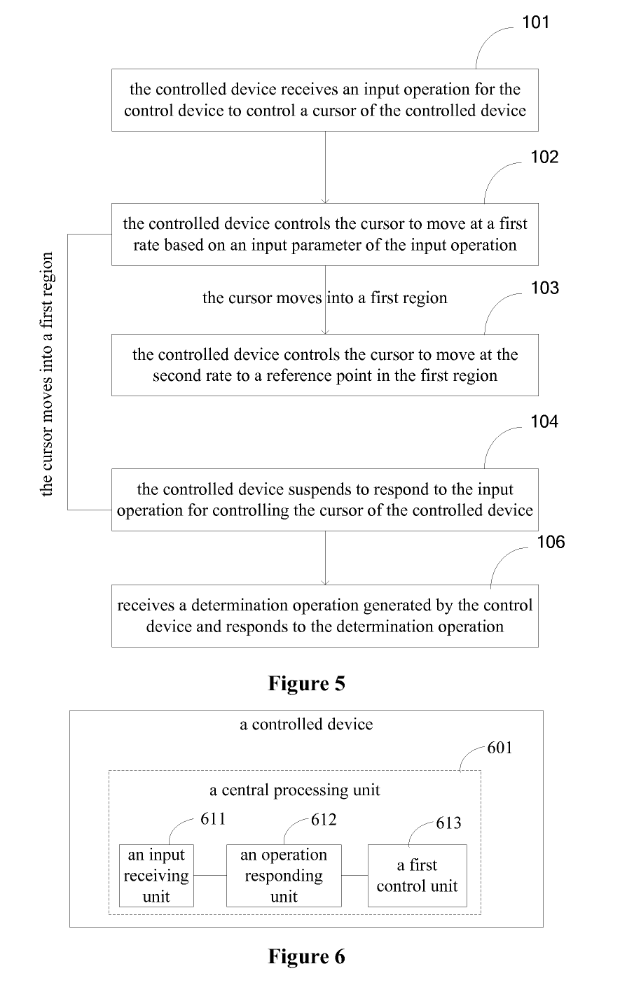

Reference is made to FIG. 5, which is a flow chart of an information processing method according to a fourth embodiment of the disclosure. After step 104, the information processing method further includes step 106.

In step 106, the controlled device receives a determination operation generated by the control device and responds to the determination operation.

When the cursor is in the first region, the user operates the control device to generate the determination operation for the controlled device, such as a click selection operation. In the present embodiment, the determination operation is received and responded to, to implement the functions of starting an application corresponding to an icon, opening a web object corresponding to a link, or the like.

Alternatively, step 106 is executed after step 105, which also falls within the scope of the disclosure.

Reference is made to FIG. 6, which is a schematic structural diagram of a controlled device according to a fifth embodiment of the disclosure. The controlled device is connected to a control device through a communication module. The control device may be a mouse such as a wired mouse, a wireless mouse, and an airmouse. The control device may be connected to the controlled device through a wired communication module or a wireless communication module, such as a wired connection module with a serial interface or a wireless connection module such as Bluetooth and WiFi, to control a cursor of the controlled device.

In the present embodiment, the controlled device includes a central processing unit 601. The central processing unit 601 may include an input receiving unit 611, an operation responding unit 612 and a first control unit 613.

The input receiving unit 611 is configured to receive an input operation for the control device to control a cursor of the controlled device.

The input operation may be a touch slide operation or the like. A user operates the control device to generate operating data for controlling the cursor of the controlled device.

The operation responding unit 612 is configured to: control the cursor to move at a first rate based on an input parameter from the input operation in response to the input operation, and trigger the first control unit 613 when the cursor moves into a first region in which a first object is displayed.

The input parameter from the input operation may include: a direction of the operation, a magnitude of the operation, a length of the operation track and a duration of operation sliding or the like. In the present embodiment, the input operation is responded to and a second rate at which the cursor moves is determined based on the input parameter.

It should be noted that the first region may be a region on a display interface corresponding to the controlled device, and there may be multiple first regions displayed in the display interface. The cursor may slide or stay in any one of the first regions when the user controls the cursor of the controlled device through the control device, as shown in FIG. 2a.

The first object displayed in the first region may be a single object, and may also be a sub-object of combination of multiple sub-objects. Such as a single icon in the icon object or a text or image object of a hyperlink object including multiple text or image objects, as shown in FIG. 2b.

The first control unit 613 is configured to control the cursor to move at the second rate to a reference point in the first region.

It can be seen from the above description, in the present embodiment, after the second rate is determined based on the input parameter, the cursor is controlled to move at the second rate in the first region, and the moving direction of the cursor is a direction toward the reference point in the first region.

It should be noted that there may be multiple reference points in the first region. The reference point may be in a center region of the first region. For example, the reference point is positioned at a center point of the first region, or the reference point is positioned in a center line of the first region. That is, the moving direction of the cursor in the first region may be a direction toward any one of the reference points in the first region. As shown in FIG. 2c, the reference points in the first region are connected into a reference line. In the present embodiment, the cursor is controlled to move at the second rate toward the reference line after the cursor enters into the first region.

The first rate is less than the second rate.

In the present embodiment, after the cursor enters into the first region, the cursor is controlled to move at a rate greater than the first rate to the reference point, in order to reach the reference point as soon as possible. Once the cursor reaches the reference point, the cursor stops moving, thereby the cursor jitter is avoided.

In the present embodiment, if the user operates the control device to generate the input operation for the control device to control the cursor of the controlled device, the input operation is received and the cursor is controlled to move at the first rate in response to the input operation. When the cursor moves into any one of the first regions, the cursor is controlled to move at the rate greater than the first rate to the reference point or the reference line including multiple reference points in the first region, and the cursor is controlled to not move at the first rate. In the embodiment, the cursor is always in the first region regardless of whether subsequent operations such as click are performed on the cursor, thereby avoiding the cursor jitter.

As can be seen form the above technical solutions, in the controlled device according to the fifth embodiment of the disclosure, the controlled device responds to the input operation for controlling the cursor of the controlled device after receiving the input operation, and control the cursor to move at the second rate greater than the first rate to the reference point in the first region when the cursor moves at the first rate into the first region. So that the cursor is always in the first region to respond to operations regardless of whether subsequent operations such as click are performed on the cursor. In this way, slight drift of the cursor such as the cursor jitter is avoided, and the accuracy of subsequent operations such as click is further improved, thereby improving user experience.

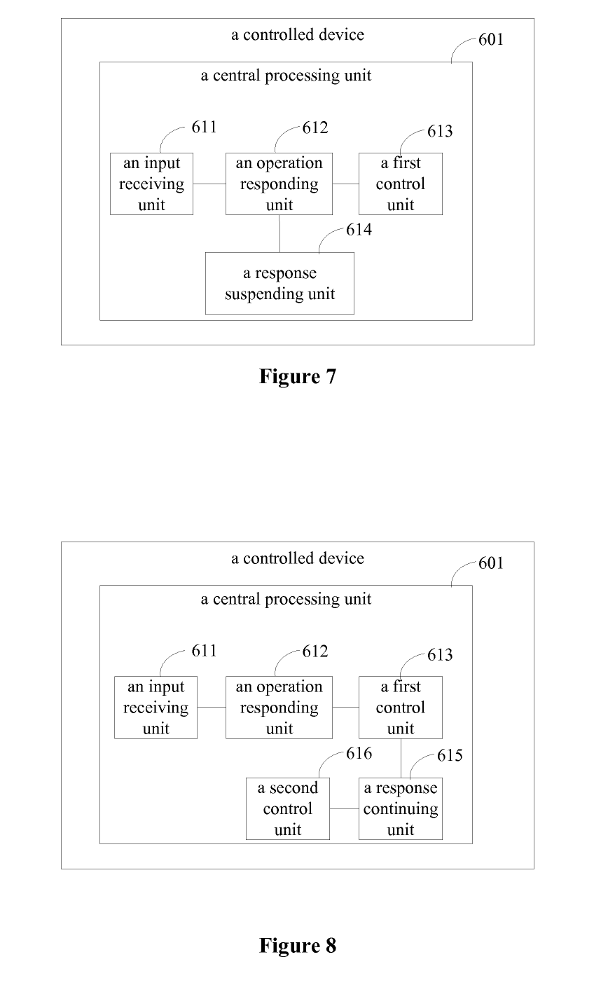

Reference is made to FIG. 7, which is a schematic structural diagram of a controlled device according to a sixth embodiment of the disclosure. The central processing unit 601 may further include a response suspending unit 614.

The response suspending unit 614 is configured to suspend to respond to the received input operation for controlling the cursor of the controlled device when the cursor moves into the first region.

In the present embodiment, responding to the received input operation for controlling the cursor of the controlled device is suspended when the cursor moves to the reference point in the first region, so that the cursor stays at the reference point before other operations are received, the stability of the cursor is ensured, thereby avoiding the cursor jitter.

Reference is made to FIG. 8, which is a schematic structural diagram of a controlled device according to a seventh embodiment of the disclosure. The central processing unit 601 may further include a response continuing unit 615 and a second control unit 616.

The response continuing unit 615 is configured to continue to respond to the received input operation for controlling the cursor of the controlled device and trigger the second control unit 616.

The second control unit 616 is configured to control the cursor to move at a third rate, where the third rate is less than the first rate.

In the present embodiment, responding to the received input operation for controlling the cursor of the controlled device is continued after the cursor moves to the reference point in the first region. The responding action in this case is different form the responding action in the case that the cursor is not in the first region. That is, in the present embodiment, the cursor is controlled to move at the third rate less than the first rate to a region such as an edge region of the first region. Hence, the moving rate at which the cursor moves in the first region is reduced, and a moving distance the cursor moves in a preset period is reduced. In this way, the stability of the cursor is ensured in a certain degree with ensuring the responding to the input operation, thereby avoiding the violent cursor jitter.

It should be noted that a first difference between the first rate and the third rate is equal to a second difference between the first rate and the second rate.

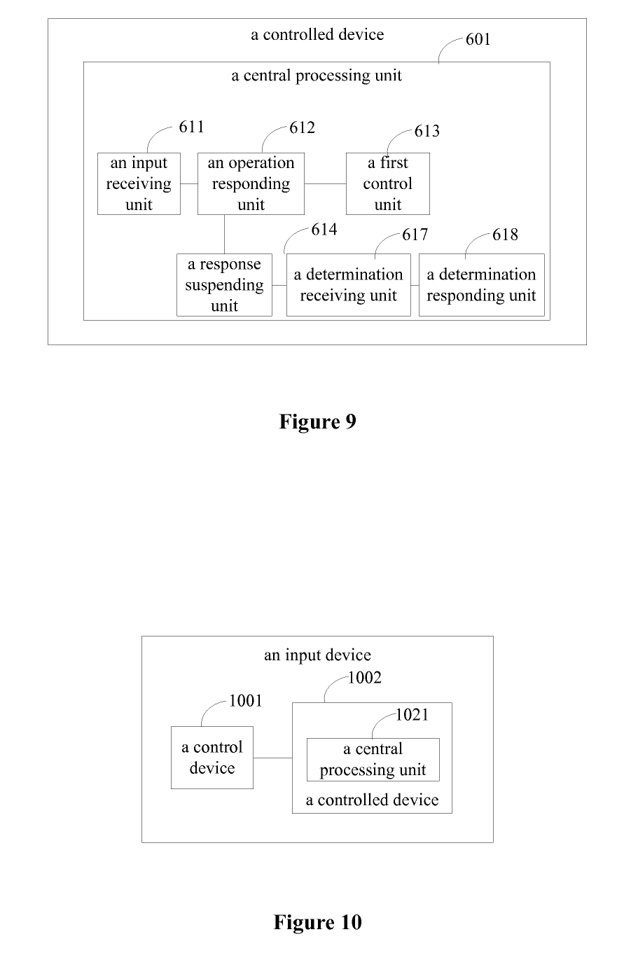

Reference is made to FIG. 9, which is a schematic structural diagram of a controlled device according to an eighth embodiment of the disclosure. The central processing unit 601 may further include a determination receiving unit 617 and a determination responding unit 618.

The determination receiving unit 617 is configured to receive a determination operation generated by the control device.

The determination responding unit 618 is configured to respond to the determination operation.

When the cursor is in the first region, the user operates the control device to generate the determination operation for the controlled device, such as a click selection operation. In the present embodiment, the determination operation is received and responded to, to implement the functions of starting an application, opening a web object corresponding to a link, or the like.

Reference is made to FIG. 10, which is a schematic structural diagram of an input device according to a ninth embodiment of the disclosure. The input device may include a control device 1001 and the controlled device 1002 according to any one of above embodiments.

The controlled device 1002 includes a central processing unit 1021 configured to: receive an input operation for the control device 1001 to control a cursor of the controlled device 1002, control the cursor to move at a first rate based on an input parameter of the input operation in response to the input operation, and control the cursor to move at a second rate to a reference point in a first region in which a first object is displayed when the cursor moves into the first region.

The first rate is less than the second rate.

In the present embodiment, the controlled device responds to the input operation for controlling the cursor of the controlled device after receiving the input operation, and control, through the central processing unit, the cursor to move at the second rate greater than the first rate to the reference point in the first region when the cursor moves at the first rate into the first region, so that the cursor is always in the first region to respond to operations regardless of whether subsequent operations such as click are performed on the cursor. In this way, slight drift of the cursor such as the cursor jitter is avoided, and the accuracy of subsequent operations such as click is further improved, thereby improving user experience.

Specifically, for the specific structure and implementation of the central processing unit 1021 included in the controlled device 1002, corresponding content described in previous embodiment may be referred to, which is not described herein.

It should be noted that the embodiments of the present disclosure are described herein in a progressive manner, with an emphasis placed on explaining the difference between each embodiment and the other embodiments; hence, for the same or similar parts among the embodiments, they can be referred to from one another.

It should be noted that the terminologies of ‘include’, ‘including’ and any other variants in the disclosure are intended to cover non-exclusive contains, so that the processes, methods, articles or devices including a series of elements not only include those elements but also include other elements that are not listed definitely or also include the elements inherent in the processes, methods, articles or devices. In the case of no more restrictions, the elements defined by the statement ‘include one . . . ’ do not exclude that other same elements also exist in the processes, methods, articles or devices including the elements.

The information processing method, the controlled device and the input device according to the disclosure are described in detail as above. The principles and the embodiments of the disclosure are described herein by using specific embodiment. However, the description of the above-mentioned embodiments is only for helping to understand the method and the core concept of the disclosure. Moreover, for the skilled in the art, modifications may be made to the embodiments and the applications in the light of the concept of the disclosure. As a result, the content in this application should not be understood as limiting the present disclosure.

What is claimed is:

1. A method for controlling a cursor, comprising:
receiving an input operation of a control device to control the cursor;
controlling the cursor to move at a first rate based on an input parameter from the input operation and
controlling the cursor to move at a second rate in a first region, wherein
the first rate is less than the second rate.

2. The information processing method according to claim 1, wherein the controlling the cursor to move at a second rate in a first region comprises:
controlling the cursor to move at the second rate to a reference point in the first region.

3. The information processing method according to claim 1, further comprising:
suspending to respond to the input operation for controlling the cursor in the first region.

4. The information processing method according to claim 1, wherein after the controlling the cursor to move at a second rate in a first region, the information processing method further comprises:
continuing to respond to the input operation for controlling the cursor, and controlling the cursor to move at a third rate, wherein the third rate is less than the first rate.

5. The information processing method according to claim 4, wherein a first difference between the first rate and the third rate is equal to a second difference between the first rate and the second rate.

6. The information processing method according to claim 3, further comprising:
receiving a determination operation generated by the control device and responding to the determination operation.

7. The information processing method according to claim 4, further comprising:
receiving a determination operation generated by the control device and responding to the determination operation.

8. An electronic device, comprising:
an input receiving unit, configured to receive an input operation of a control device to control a cursor;
an operation responding unit, configured to control the cursor to move at a first rate based on an input parameter of the input operation, and trigger a first control unit when the cursor moves into a first region; and
the first control unit, configured to control the cursor to move at a second rate in the first region, wherein
the first rate is less than the second rate.

9. The electronic device according to claim 8, wherein the first control unit is further configured to control the cursor to move at the second rate to a reference point in the first region.

10. The electronic device according to claim 8, further comprising:
a response suspending unit, configured to suspend to respond to the input operation for controlling the cursor in the first region.

11. The electronic device according to claim 8, further comprising:
a response continuing unit, configured to continue to respond to the input operation for controlling the cursor and trigger a second control unit; and
the second control unit, configured to control the cursor to move at a third rate, wherein the third rate is less than the first rate.

12. The electronic device according to claim 11, wherein a first difference between the first rate and the third rate is equal to a second difference between the first rate and the second rate.

13. The controlled device according to claim 10, further comprising:
a determination receiving unit, configured to receive a determination operation generated by the control device; and
a determination responding unit, configured to respond to the determination operation.

14. The electronic device according to claim 11, wherein the central processing unit further comprises:
a determination receiving unit, configured to receive a determination operation generated by the control device; and
a determination responding unit, configured to respond to the determination operation.

15. An input device comprising a control device and the electronic device according to claim 8.
